(19) United States
(12) Patent Application Publication
(10) Pub. No.: US 2024/0340980 A1
(43) Pub. Date: Oct. 10, 2024

(54) SYSTEM ARCHITECTURE FOR DIRECT NTN COMMUNICATION WITHOUT A FEEDER LINK

(71) Applicant: QUALCOMM Incorporated, San Diego, CA (US)

(72) Inventors: Lianghai JI, San Diego, CA (US); Jun MA, San Diego, CA (US); Hong CHENG, Basking Ridge, NJ (US); Mohamad SAYED HASSAN, Paris (FR)

(21) Appl. No.: 18/295,663

(22) Filed: Apr. 4, 2023

(51) Int. Cl. H04W 76/10

(52) U.S. Cl. CPC H04W 76/10; H04W 84/06

(57) ABSTRACT

A method for wireless communication at a network entity and related apparatus are provided. In the method, the network entity receives, from a first user equipment (UE), a communication signal for an end-to-end (E2E) communication with a second UE. The communication signal includes identification data for identifying the second UE for the E2E communication. The network entity further routes the communication signal through the network entity, where the communication signal bypasses ground-based feeder links, and transmits, to the second UE, the communication signal to enable the E2E communication between the first UE and the second UE.

### TECHNICAL FIELD

The present disclosure relates generally to communication systems, and more particularly, to system architecture for direct non-terrestrial network (NTN) communication without a feeder link.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a first user equipment (UE). The apparatus may include memory and at least one processor coupled to the memory. Based at least in part on information stored in the memory, the at least one processor may be configured to generate identification data identifying a second UE for a direct non-terrestrial network (NTN) communication; and transmit, to a network entity, a communication signal including the identification data for the network entity to route the communication signal to the second UE to enable the direct NTN communication with the second UE, where the communication signal bypasses ground-based feeder links.

In an aspect of the disclosure, a method, a computer-readable medium, and an apparatus are provided for wireless communication at a network entity. The apparatus may include memory and at least one processor coupled to the memory. Based at least in part on information stored in the memory, the at least one processor may be configured to receive, from a first UE, a communication signal for a direct NTN communication with a second UE, where the communication signal includes identification data for identifying the second UE for the direct NTN communication; route the communication signal through the network entity, where the communication signal bypasses ground-based feeder links; and transmit, to the second UE, the communication signal to enable the direct NTN communication between the first UE and the second UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of NTN communication with a feeder link.

FIG. 5A is a diagram illustrating an example of an NTN coverage.

FIG. 5B is a diagram illustrating an example of NTN coverage extension through an ISL.

FIG. 6A is a diagram illustrating an example of data routing in the control plane by an NTN platform with CN functions in accordance with various aspects of the present disclosure.

FIG. 6B is a diagram illustrating an example of data routing in the user plane by an NTN platform with CN functions in accordance with various aspects of the present disclosure.

FIG. 7A is a diagram illustrating an example of a UE's control plane connection to an NTN platform with onboard relay functions in accordance with various aspects of the present disclosure.

FIG. 7B is a diagram illustrating an example of data routing in the user plane by an NTN platform with onboard relay functions in accordance with various aspects of the present disclosure.

FIG. 8 is a diagram illustrating an example of data routing on a control plane in accordance with various aspects of the present disclosure.

FIG. 9 is a diagram illustrating an example of data routing on a user plane in accordance with various aspects of the present disclosure.

FIG. 10 is a diagram illustrating an example of data routing on a control plane for an E2E link in accordance with various aspects of the present disclosure.

FIG. 11 is a diagram illustrating an example of data routing on the user plane for an E2E link in accordance with various aspects of the present disclosure.

FIG. 12 is a diagram illustrating an example of data routing on a control plane for an E2E link in accordance with various aspects of the present disclosure.

FIG. 13 is a diagram illustrating an example of the NTN platform functioning as an SL relay in accordance with various aspects of the present disclosure.

FIG. 14 is a call flow diagram illustrating a method of wireless communication in accordance with various aspects of the present disclosure.

FIG. 15 is a flowchart illustrating methods of wireless communication at a network entity in accordance with various aspects of the present disclosure.

FIG. 16 is a flowchart illustrating methods of wireless communication at a network entity in accordance with various aspects of the present disclosure.

FIG. 17 is a flowchart illustrating methods of wireless communication at a UE in accordance with various aspects of the present disclosure.

FIG. 18 is a flowchart illustrating methods of wireless communication at a UE in accordance with various aspects of the present disclosure.

FIG. 19 is a diagram illustrating an example of a hardware implementation for an example apparatus and/or network entity.

FIG. 20 is a diagram illustrating an example of a hardware implementation for an example network entity.

### DETAILED DESCRIPTION

Various aspects relate generally to communication systems. Some aspects more specifically relate to system architecture for direct NTN communication without a feeder link. In some examples, a network entity may be configured to receive, from a first UE, a communication signal for an end-to-end (E2E) communication with a second UE. The communication signal may include identification data for identifying the second UE for the E2E communication. The network entity may be further configured to route the communication signal through the network entity, where the communication signal bypasses ground-based feeder links; and transmit, to the second UE, the communication signal to enable the E2E communication between the first UE and the second UE. In some aspects, the E2E communication may be a direct NTN communication. In some aspects, the network entity may be equipped with a set of core network functions, and may route the communication signal through the set of core network functions. In some aspects, the network entity may be equipped with an onboard relay function, and may route the communication signal through the onboard relay function.

Particular aspects of the subject matter described in this disclosure can be implemented to realize one or more of the following potential advantages. In some examples, by using a network entity to route communication signals from one UE to another UE and bypass ground-based feeder links, the described techniques can be used to reduce latency and feeder link load by enabling direct NTN communication between UEs. Additionally, by enabling direct NTN communication between UEs without a feeder link, the described techniques may be used to provide better service availability and reliability where a feeder link is unavailable.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

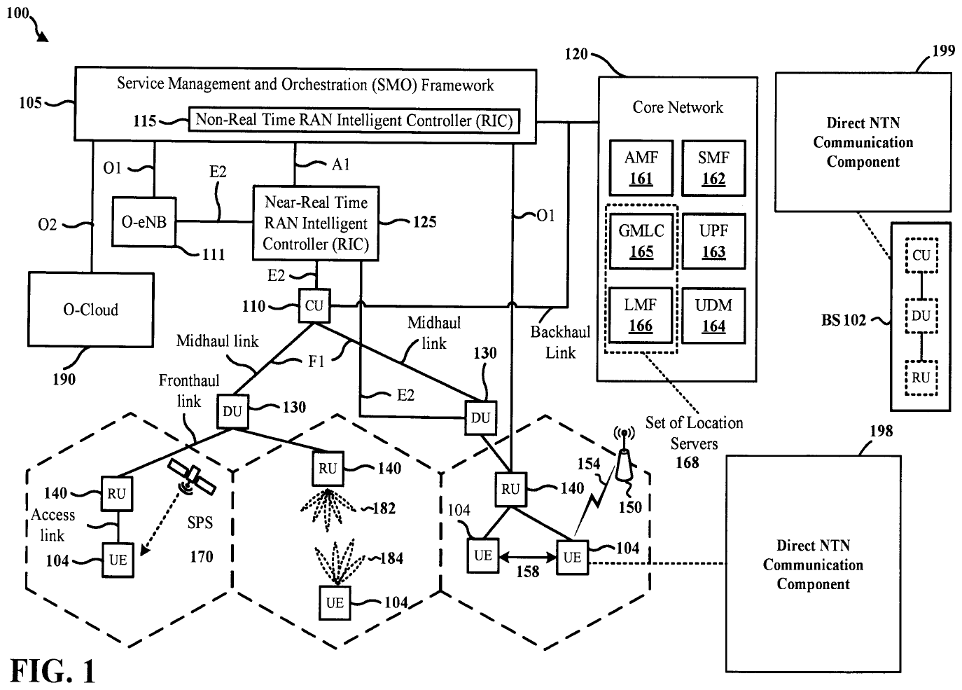

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-CNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHZ (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2. FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a direct NTN communication component 198. The direct NTN communication component 198 may be configured to generate identification data identifying a second UE for a direct NTN communication; and transmit, to a network entity, a communication signal including the identification data for the network entity to route the communication signal to the second UE to enable the direct NTN communication with the second UE, where the communication signal bypasses ground-based feeder links. In certain aspects, the base station 102 may include a direct NTN communication component 199. The direct NTN communication component 199 may be configured to receive, from a first UE, a communication signal for a direct NTN communication with a second UE, where the communication signal includes identification data for identifying the second UE for the direct NTN communication; route the communication signal through the network entity, where the communication signal bypasses ground-based feeder links; and transmit, to the second UE, the communication signal to enable the direct NTN communication between the first UE and the second UE. Although the following description may be focused on 5G NR, the concepts described herein may be applicable to other similar areas, such as LTE, LTE-A, CDMA, GSM, and other wireless technologies.

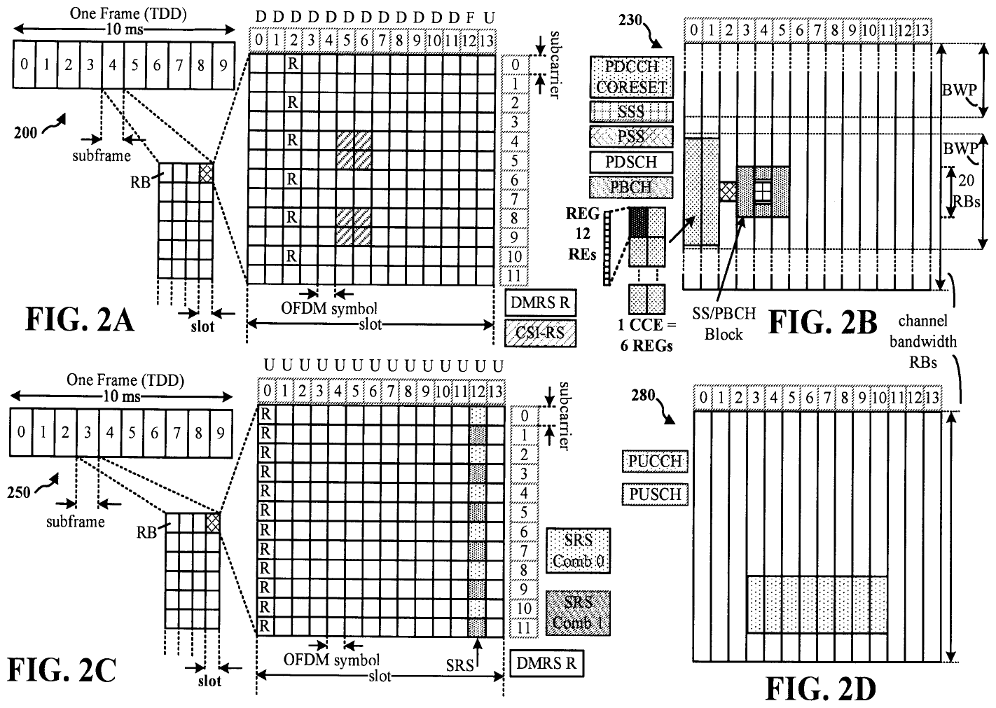

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

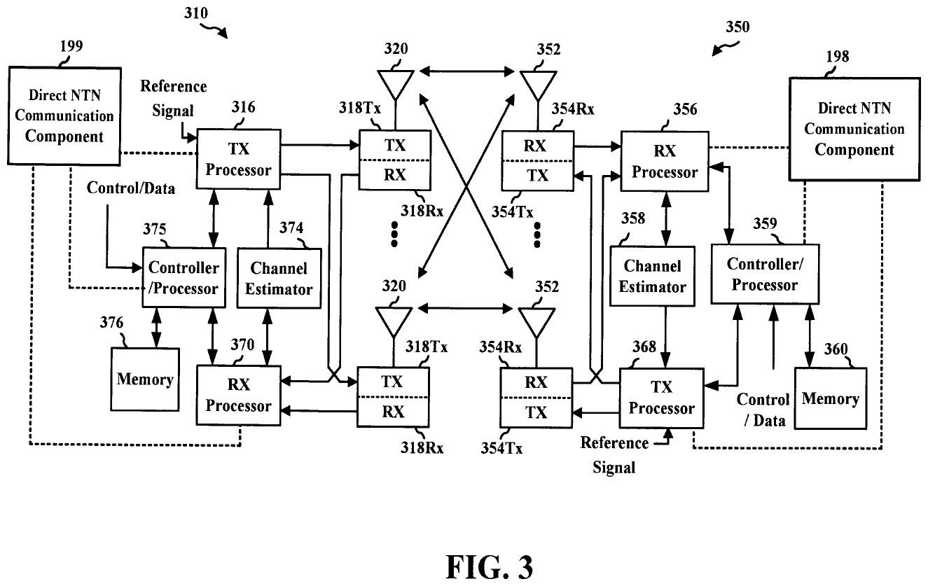

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ. priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the direct NTN communication component 198 of FIG. 1.

At least one of the TX processor 316, the RX processor 370, and the controller/processor 375 may be configured to perform aspects in connection with the direct NTN communication component 199 of FIG. 1.

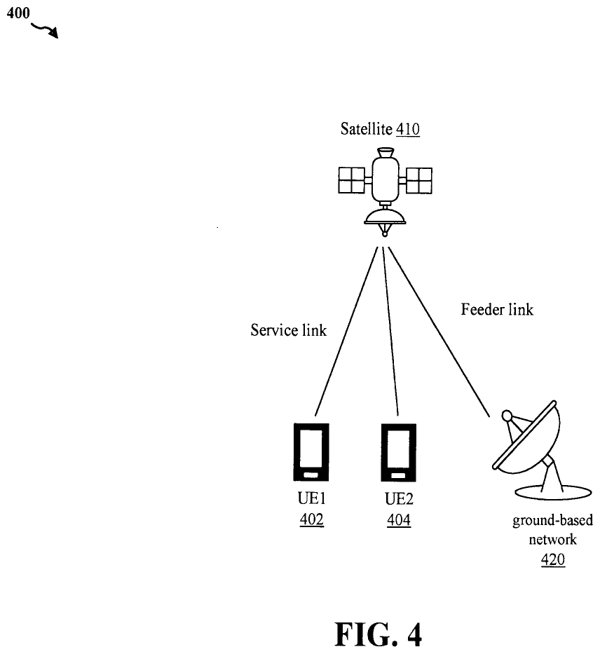

In traditional satellite communication, a satellite may be connected with ground-based network infrastructure, which may serve as a Non-Terrestrial Network (NTN) gateway, through a feeder link to facilitate data transmission within the NTN. FIG. 4 is a diagram 400 illustrating an example of NTN communication with a feeder link. In FIG. 4, the first UE (UE1 402) may communicate with the second UE (UE2 404) via a satellite 410, which is connected to a ground-based network 420 via a feeder link. During this process, the satellite 410 may function as either a transparent satellite, which receives the communication signal from the UE and retransmits it back to the ground or another UE without significant onboard signal processing, or a regenerative satellite, which performs onboard signal processing and routing on the received communication signal. A regenerative satellite may carry out the onboard signal processing related to the base station function (e.g., gNB function) with or without inter-satellite links (ISL) for communication with neighboring satellites. In some examples, a regenerative satellite may incorporate gNB-DU functions and process gNB-DU payloads, such as Physical (PHY) layer processing, Medium Access Control (MAC) layer processing, and Radio Link Control (RLC) layer processing.

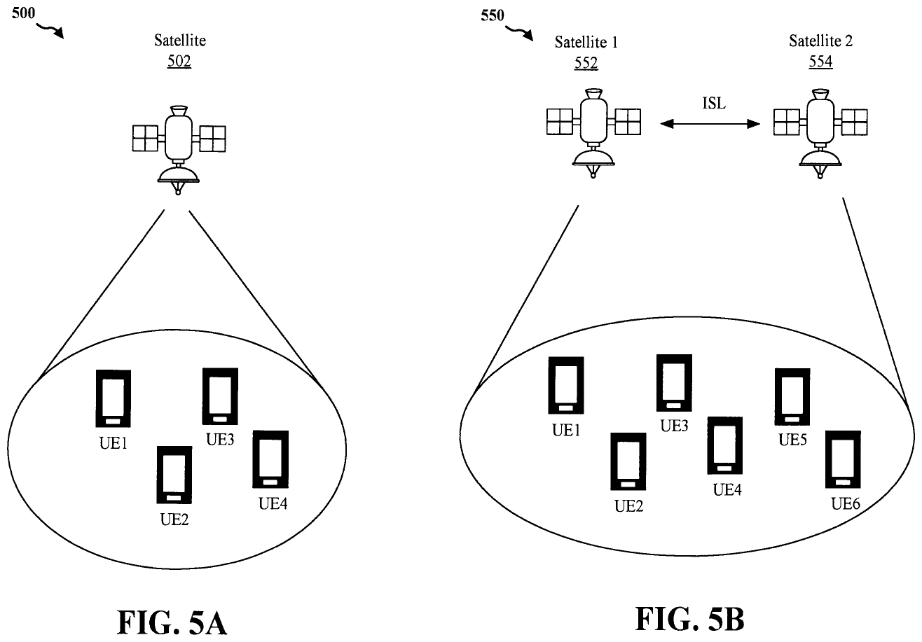

In an environment where the NTN provides extensive coverage, there is a high probability that two communicating UEs will be covered by the same NTN, and the use of ISLs between nearby satellites may further expand the coverage area for direct NTN communication, improving the connectivity between UEs. By enabling direct communication between UEs without needing a ground network (NW), latency and feeder link load may be reduced, allowing for communication even in the presence of feeder link coverage holes. FIG. 5A is a diagram 500 illustrating an example of an NTN coverage. In FIG. 5A, multiple UEs (e.g., UE1, UE2, UE3, and UE4) may be within the coverage area of a satellite 502. FIG. 5B is a diagram 550 illustrating an example of NTN coverage extension through an ISL. In FIG. 5B, multiple satellites (e.g., satellite 1 552 and satellite 554) may be connected through the ISL to expand the coverage area for direct NTN communication. This allows more UEs (e.g., UE1 through UE6) to be covered than what a single satellite (e.g., satellite 502) can provide.

Moreover, utilizing the control-plane features without the involvement of a ground NW may enhance the overall performance and efficiency of the communication system. This capability may support scenarios in which a feeder link to the ground NW becomes unavailable, thereby enabling future NTN networks to operate independently from Terrestrial Networks (TN NW).

Example aspects presented herein provide a system architecture that does not rely on the feeder link to the ground NW and allows for NTN communication without the gateway. This is especially important when the feeder link becomes unavailable for the NTN NW.

In some aspects, an NTN platform may be equipped with a base station (gNB) and Core Network (CN) functions. The base station may include the functions required for a (radio) access network, e.g., which manages the functions at the access stratum (AS) layer. The CN functions may include at least one of the User Plane Function (UPF), the Access and Mobility Management Function (AMF), the Session Management Function (SMF), and/or the Data Network (DN) or server capabilities. The data may be routed by the onboard CN/DN from one UE to its peer UE(s). As used herein, a non-terrestrial network, or “NTN,” may refer to a communication network that primarily utilizes satellites or other airborne platforms to provide connectivity. An “NTN platform” may refer to the network infrastructure (e.g., a satellite) that provides connectivity in the NTN network, and “NTN communication” refers to the communication that goes through NTN.

A potential impact of aspects of the present disclosure on the CN includes the dynamic interconnection among moving satellites, CN nodes, and/or the UE, and the switching between serving satellites. The incorporation of the CN functions may result in increased satellite complexity and power consumption due to the integration of multiple network components and functionalities onto the satellite. To address these challenges, the proposed solutions may be transparent to the Radio Access Network (RAN) or have small impact on the RAN.

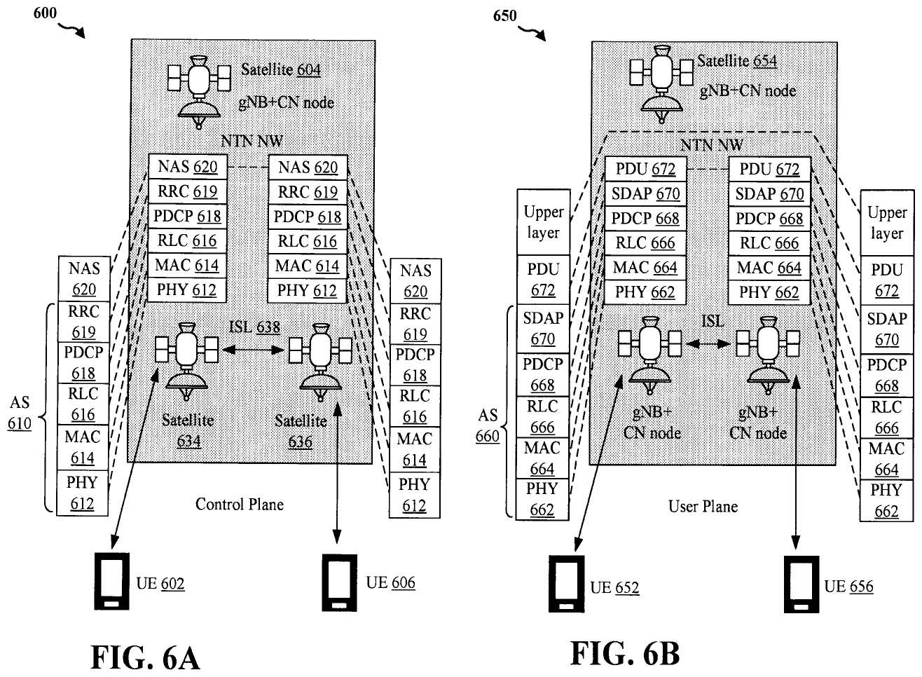

FIG. 6A is a diagram 600 illustrating an example of data routing in the control plane by an NTN platform with CN functions in accordance with various aspects of the present disclosure. In FIG. 6A, the NTN platform (e.g., satellite 604) may be equipped with CN functions, and may route the control plane data by the onboard CN/DN from one UE (e.g., UE 602) to the CN functions residing in the NTN platform (e.g., satellite 634). The communication between the UE (e.g., UE 602) and the NTN platform (e.g., satellite 634) may include data on the AS layer 610, which may include the PHY layer 612, the MAC layer 614, the RLC layer 616, the PDCP layer 618, the RRC layer 619. Additionally, the NTN platform (e.g., satellite 634) may terminate the Non-Access Stratum (NAS) layer 620 (a layer between the UE and the CN node) with the UE (e.g., UE 602) on the control plane. In some aspects, the CN functions residing on different satellites may interconnect and/or coordinate with each other. FIG. 6B is a diagram 650 illustrating an example of data routing in the user plane by an NTN platform with CN functions in accordance with various aspects of the present disclosure. In FIG. 6B, the NTN platform (e.g., satellite 654) may be equipped with CN functions, and may route the data by the onboard CN/DN from one UE (e.g., UE 652) to another UE (e.g., UE 656). The data to be routed by the NTN platform (e.g., satellite 654) may include data on the AS layer 660, which may include the PHY layer 662, the MAC layer 664, the RLC layer 666, the PDCP layer 668, and/or the SDAP layer 670. Additionally, the NTN platform (e.g., satellite 604) may also route data the Non-Access Stratum (NAS) layer on the control plane, which may include a PDU layer 672. The E2E data (e.g., data in the Upper layer) may be communicated over the AS layer and the NAS layer.

In some aspects, an NTN platform may be equipped with onboard relay functions (e.g., through an onboard relay cell), which may include a routing function, enabling E2E traffic to be routed from one UE to another UE via one or multiple satellites in the network. Furthermore, a UE-radio access network (RAN) (UE-RAN) air interface may serve as a baseline for communication between a UE and a satellite. In one example, a UE-Universal Mobile Telecommunications System (UMTS) terrestrial radio access network (UTRAN) (UE-UTRAN) (Uu) air interface may serve as a baseline for communication between a UE and a satellite. In another example, a UE-New Radio (NR) radio access network (UE-NR RAN) air interface may serve as a baseline for communication between a UE and a satellite. In some aspects, the NTN platform may be equipped with a RAN node, which integrates the routing/relay function(s). In some aspects, modifications may be made to existing protocols and procedures, especially for the Uu protocols and/or procedures above the AS layer. For instance, certain sidelink (SL) or SL-relay protocols and procedures may be considered and used to modify the Uu protocols and procedures, such as including the consideration of Sidelink (SL) security schemes and authorization schemes to ensure E2E link security and UE-authorization, respectively.

The Uu Radio Resource Control (RRC) functionality may be leveraged to provide control. By adding a relay/routing function to the onboard base station (e.g., a gNB), this approach may result in increased satellite complexity and power consumption. However, the overall increase is less than that observed in the scheme that incorporates the CN functions to the satellite. Additionally, this proposed architecture may lead to changes to the RAN-related technical specifications to accommodate the onboard relay functionalities.

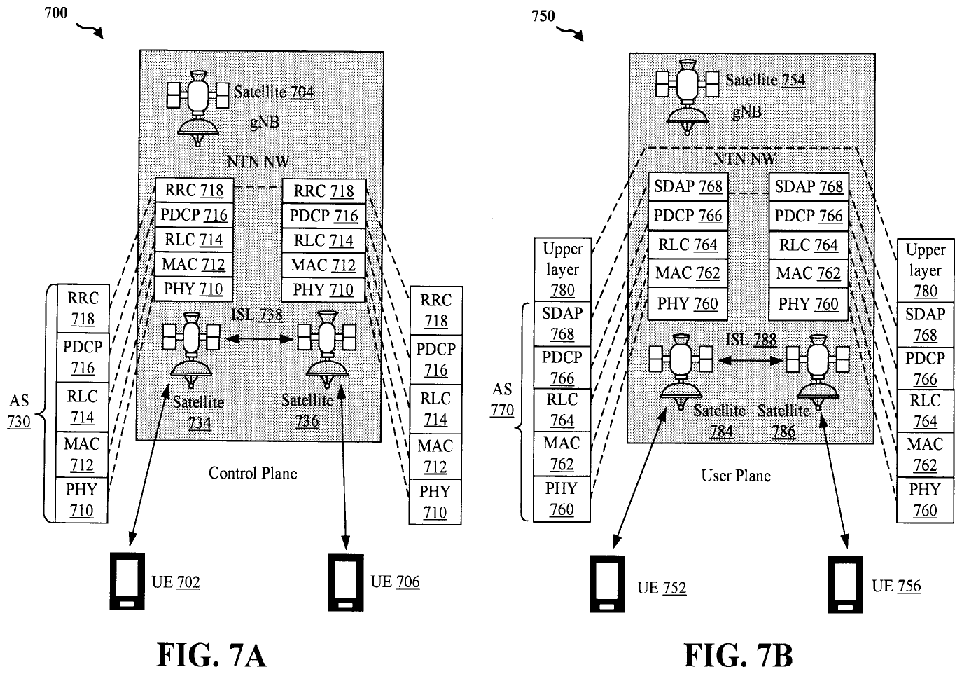

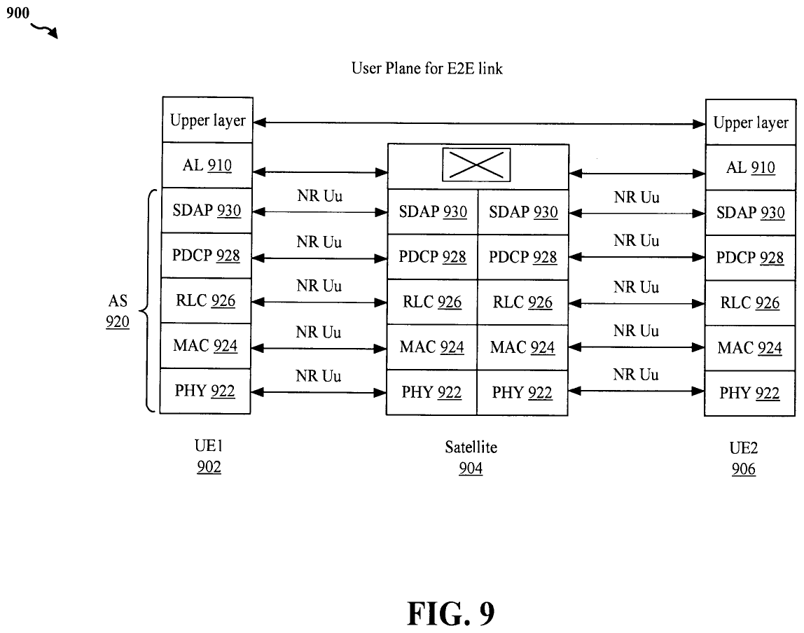

FIG. 7A is a diagram 700 illustrating an example of a UE's control plane connection to an NTN platform with onboard relay functions in accordance with various aspects of the present disclosure. In FIG. 7A, the NTN platform (e.g., satellite 704) may be equipped with onboard RAN node (e.g., a gNB), which may terminate the control plane connection of the AS layer 730 of a UE (e.g., UE 702). The control data between the UE 702 and the NTN platform (e.g., satellite 704) may be transmitted over the PHY layer 710, the MAC layer 712, the RLC layer 714, the PDCP layer 716, and the RRC layer 718 on the control plane. In some aspects, the RRC functions residing at different satellites (e.g., satellites 734, 736) may interconnect/coordinate with each other, e.g., via the ISL 738. FIG. 7B is a diagram 750 illustrating an example of data routing in the user plane by an NTN platform with onboard relay functions in accordance with various aspects of the present disclosure. In FIG. 7B, the NTN platform (e.g., satellites 784, 786 connected through an ISL 788) may be equipped with the onboard relay functions, and may relay the data from one UE (e.g., UE 752) to another UE (e.g., UE 756). The data to be relayed by the NTN platform (e.g., satellites 784, 786) may include data on the AS layer 770, which may include the PHY layer 760, the MAC layer 762, the RLC layer 764, the PDCP layer 766, and the SDAP layer 768. In some aspects, some of the listed layers may or may not be used (e.g., the SDAP layer 768 and/or the PDCP layer 766 may be optional for the AS layer 770). User data, such as the E2E data (e.g., data in the upper layer 780), may be communicated on top of the AS layer 770. In some aspects, an additional layer may be added, and the additional layer may be used for identifying the E2E communication link and/or the routing path, e.g., as shown later in FIGS. 9, 10, 11, and 12.

In some aspects, for an NTN platform equipped with onboard relay functions, a layer 3 (L3) relay mechanism may be implemented, which may utilize an onboard relay cell to manage and update routing by implementing an additional layer or function above the AS layer. This additional layer may take into consideration factors such as IP, Quality of Service (QOS) flow, radio bearer (RB), logical channel (LCH), Radio Network Temporary Identifier (RNTI), the peer UE's location, and/or a header at the additional layer or function. In some aspects, this additional layer may be referred to as the identification layer.

When each UE is limited to communicating with one peer UE, routing can be performed based on the transmitting UE's identity. The UE may be controlled by the NTN node via the Uu interface, allowing it to reside in different RRC states, obtain proper AS configuration, and support mobility. For transmitting the user plane data of the E2E link, the UE may employ the Uu radio protocol stack. To facilitate this approach, an additional layer or function may be implemented at the UE.

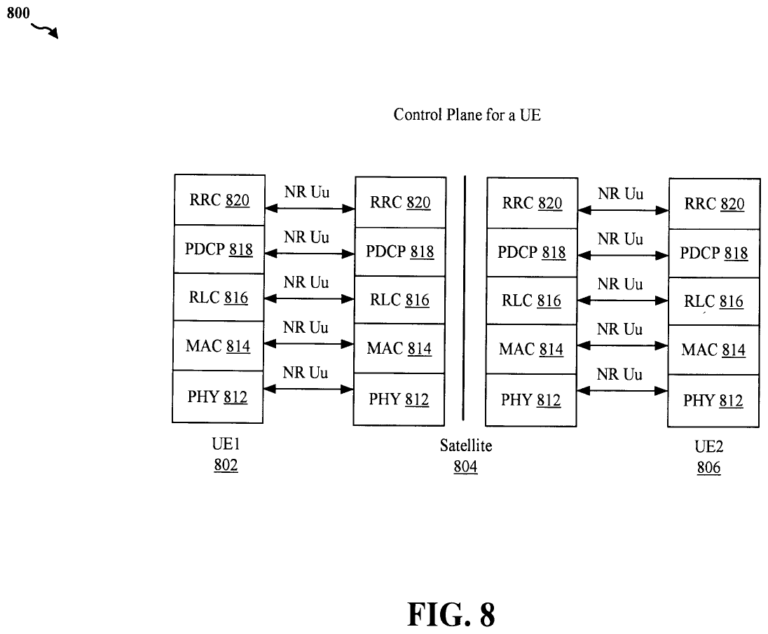

FIG. 8 is a diagram 800 illustrating an example of data routing on a control plane in accordance with various aspects of the present disclosure. In FIG. 8, a UE (e.g., UE1) may connect with a satellite 804 via the Uu air interface for the PHY layer 812, the MAC layer 814, the RLC layer 816, the PDCP layer 818, and the RRC layer 820. The satellite 804 may have different RRC entities, each corresponding to one UE. That is, the satellite 804 may use one RRC entity to control the operation of UE1 802 and use another RRC entity to control the operation of UE2 806.

FIG. 9 is a diagram 900 illustrating an example of data routing on a user plane in accordance with various aspects of the present disclosure. In FIG. 9, the UE (UE1 802) may apply the Uu air interface for transmitting the user plane data for E2E links. An additional layer (AL) layer 910 may be implemented over the AS layer 920 (which may include the PHY layer 922, the MAC layer 924, the RLC layer 926, the PDCP layer 928, and/or the SDAP layer 930). The AL layer 910 may be used to transmit data for identifying the source UE (e.g., UE1 902) and/or the destination UE of the data (e.g., UE2 906). The data for identifying the source UE (e.g., UE1 902) and/or the destination UE (e.g., UE2 906) may be based on the IP address of the source UE (e.g., UE1 902) and/or destination UE (e.g., UE2 906), the QoS flow associated to the data, the RB associated to the data, the LCH associated to the data, the RNTI of the source UE and/or the destination UE, the peer/destination UE's location, and/or a header at the additional layer. In some aspects, the data for identifying the source UE (e.g., UE1 902) and/or the destination UE (e.g., UE2 906) may be attached and/or associated to a packet, which is to be transmitted to the destination UE (e.g., UE2 906). After the NTN platform/node receives the packet, the NTN platform may use the data for identifying the destination UE (e.g., UE2 906) to forward the packet to the destination UE (e.g., UE2 906). In some aspects, the data for identifying the source UE (e.g., UE1 902) and/or the destination UE (e.g., UE2 906) may be transmitted together with the packet to the destination UE (e.g., UE2 906). Thus, upon receiving the data for identifying the source UE (e.g., UE1 902) and/or the destination UE (e.g., UE2 906), the destination UE (e.g., UE2 906) can be aware of the source UE (e.g., UE1 902), which generated the packet. In some aspects, before the data for identifying the source UE (e.g., UE1 902) and/or the destination UE (e.g., UE2 906) is transmitted by the NTN platform/node to the destination UE (e.g., UE2 906), the NTN platform/node may process and/or modify the data, such that the data can be correctly understood by the destination UE (e.g., UE2 906). When the transmitting UE (UE1 902) is limited to communicating with one peer/destination UE, the data for identifying the destination UE (e.g., UE2 906) may be based on the identity of the transmitting UE (UE1 902).

In some aspects, two UEs may establish an E2E control layer, such as an E2E RRC/NAS layer, which is transported over NTN node(s) and the NR Uu PDCP layer and the layers below the PDCP layer. This E2E RRC/NAS layer may be employed for optimizing the E2E and joint link control, such as E2E link setup and release, and link mobility management.

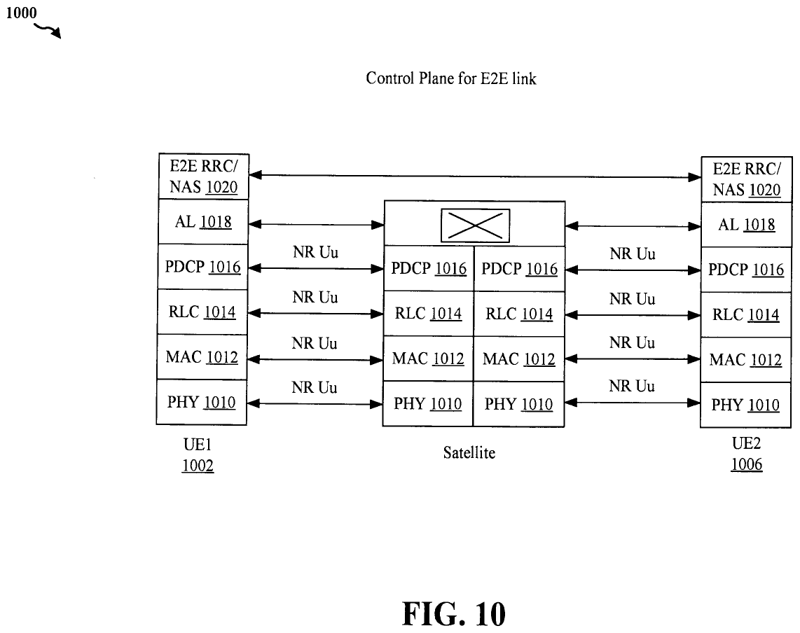

FIG. 10 is a diagram 1000 illustrating an example of data routing on a control plane for an E2E link in accordance with various aspects of the present disclosure. In FIG. 10, an E2E RRC/NAS layer 1020 may be implemented for one UE (e.g., UE1 1002) to control and/or coordinate the operation of another UE (e.g., UE2 1006). The E2E RRC/NAS layer 1020 may be transmitted on top of the AL layer 1018, the PDCP layer 1016, the RLC layer 1014, the MAC layer 1012, and the PHY layer 1010. In some aspects, after the NTN platform/node receives an E2E RRC/NAS data from the transmitting UE (e.g., UE1 1002), the NTN platform may use the information associated to the AL layer 1018 to identify the destination UE (e.g., UE2 1006) and forward the packet to the destination UE (e.g., UE2 1006).

In some aspects, a layer 2 (L2) relay mechanism that employs an onboard cell to implement an additional layer or function above the RLC layer for routing data packets may be implemented. The UE may be controlled by the NTN node via the Uu interface, enabling the UE to reside in different RRC states, obtain proper configuration, and support mobility.

For transmitting E2E user plane data, layers below the PDCP layer may terminate at each UE and the satellite, while the PDCP layer and the layers above the PDCP layer may terminate at the two end UEs. Both the Uu and PC5 interfaces may be implemented for these layers. The current PC5 PDCP and PC5 SDAP layers may be modified, and an additional layer may be added at the UE.

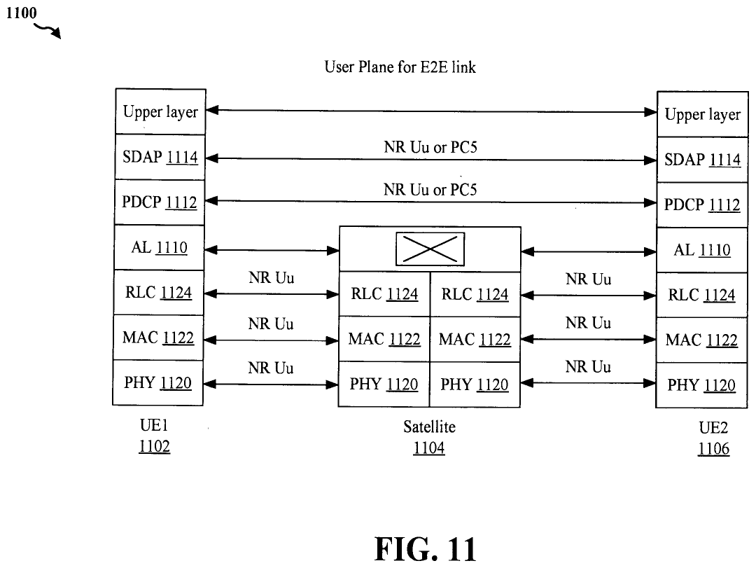

FIG. 11 is a diagram 1100 illustrating an example of data routing on the user plane for an E2E link in accordance with various aspects of the present disclosure. In FIG. 11, the UE (UE1 1102) may apply the Uu air interface for transmitting the user plane data for E2E links. An additional layer (AL) layer 1110 may be implemented on top of the RLC layer. The AL layer 1110 may be used to transmit data for identifying the destination UE of the data to be transmitted (e.g., UE2 1106). The PDCP layer 1112 and the layer above the PDCP layer may each have terminations at the two UEs (UE1 1102 and UE2 1106). The satellite 1104 may process data in the PHY layer 1120, the MAC layer 1122, the RLC layer 1124 and the AL layer 1110 from UE1 1102 and transmit the processed data to UE2 1106. The data on the PDCP layer 1112 and the SDAP layer 1114 may be transmitted to UE2 1106 through the Uu air interface or the sidelink (PC5) interface.

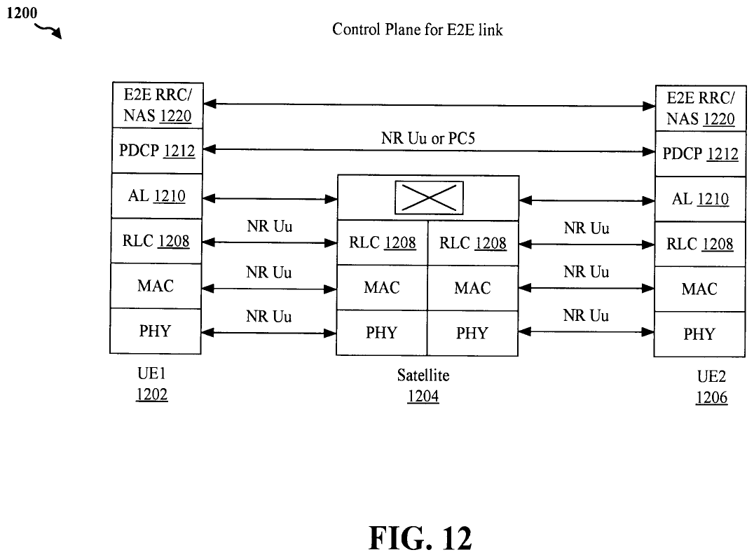

FIG. 12 is a diagram 1200 illustrating an example of data routing on a control plane for an E2E link in accordance with various aspects of the present disclosure. In FIG. 12, an E2E RRC/NAS layer 1220 may be implemented for one UE (e.g., UE1 1202) to control and/or coordinate the operation of another UE (e.g., UE2 1206). The E2E RRC/NAS layer 1220 may be transmitted on top of the PDCP layer 1212. In the example of FIG. 12, the AL layer 1210 may be on top of the RLC layer 1208.

One of the key advantages of the L2 relay mechanism is that the satellite is not involved in E2E security, which is handled at the PDCP layer 1212 terminated at the two end UEs (e.g., UE1 1202 and UE2 1206). The E2E control layer, such as an E2E RRC/NAS layer 1220, is transported over NTN node(s) and the PDCP layer 1212. The layers below the PDCP layers terminate at the satellite 1204 and each UE (e.g., UE1 1202 and UE2 1206), while the PDCP layer 1212 and the E2E RRC/NAS layer 1220 terminate at the two end UEs (UE1 1202 and UE2 1206).

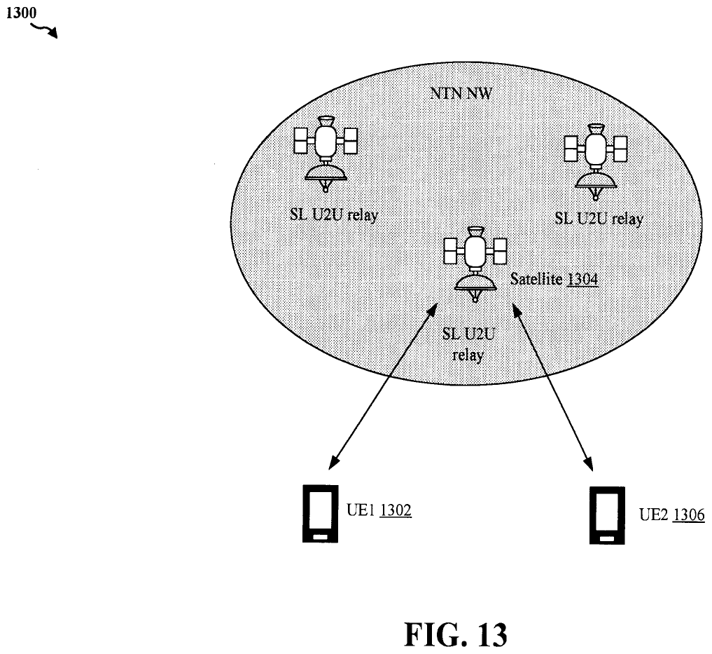

In some aspects, an NTN platform may function as a sidelink (SL) relay, e.g., as an SL UE-to-UE (U2U) relay. In this NTN platform, the NTN payload may serve as an SL relay, facilitating data transfer from one UE to another. FIG. 13 is a diagram 1300 illustrating an example of the NTN platform functioning as an SL relay in accordance with various aspects of the present disclosure. In FIG. 13, the NTN platform (satellite 1304) may receive data from, or transmit data to, the UEs (e.g., UE1 1302 and UE2 1306) through sidelink interfaces.

As the traditional sidelink design is not optimized for long-distance communication, modifications to the specifications may be implemented to accommodate this new functionality. Consequently, a distinct sidelink capability, separate from the legacy sidelink operation, might be implemented for the UE. This approach may increase satellite complexity, necessitating the use of different air interfaces for regular NTN communications that pass through the ground NW, and direct NTN communication that bypasses the ground NW.

To accommodate these different communication scenarios, the UE may implement both sidelink and Uu interfaces. However, this approach may exhibit less efficiency and robustness compared to the NTN platform that equipped with an onboard relay function, due to the inherently limited capability of the sidelink relay.

Table 2 shows various architectures for direct NTN communication in accordance with various aspects of the present disclosure.

TABLE 2
Comparison of the architectures for direct NTN communication

| | Satellite is | Satellite is | Satellite is |
|---|---|---|---|
| | equipped with | equipped with | equipped with |
| | RAN, CN | RAN node | sidelink relay |
| Routing the E2E | Supported by CN | With new | Yes |
| traffic | | function/layer | |
| | | added a RAN | |
| Impact on the | Yes (to handle | No | No |
| onboard CN nodes | mobile CN nodes) | | |
| Added satellite | High | Medium | Medium |
| complexity and | | | |
| power | | | |
| consumption | | | |
| PHY/MAC | Yes | Yes | No |
| support | | | |
| Mobility and | Limited (CN node | Good | Middle (RAN |
| service continuity | switch) | | node switch by |
| support | | | SL signaling) |
| RAN impact | No/Minimum | Yes | Yes |
| Added UE | Small | Medium | High |
| complexity | | | |

Aspects of the present disclosure introduce a novel direct NTN communication architecture that offers several functional benefits over existing approaches. This innovative architecture is designed to reduce latency and feeder link load, providing a more efficient and responsive communication experience. The direct NTN communication architecture also supports cases where a feeder link to a ground NW is unavailable or experiences a coverage hole, ensuring more reliable connectivity in challenging situations. One of the key advantages of the proposed architecture is its ability to enable a future NTN network to operate independently from a TN NW. This flexibility provides a foundation for more versatile and adaptable network configurations in the rapidly evolving communication landscape. Furthermore, the proposed system architecture aims to reuse the current protocol stack layers at the UE and satellite, minimizing additional complexity at these network elements. As a result, aspects of the present disclosure may be more commercially viable and deployment-friendly compared to existing solutions.

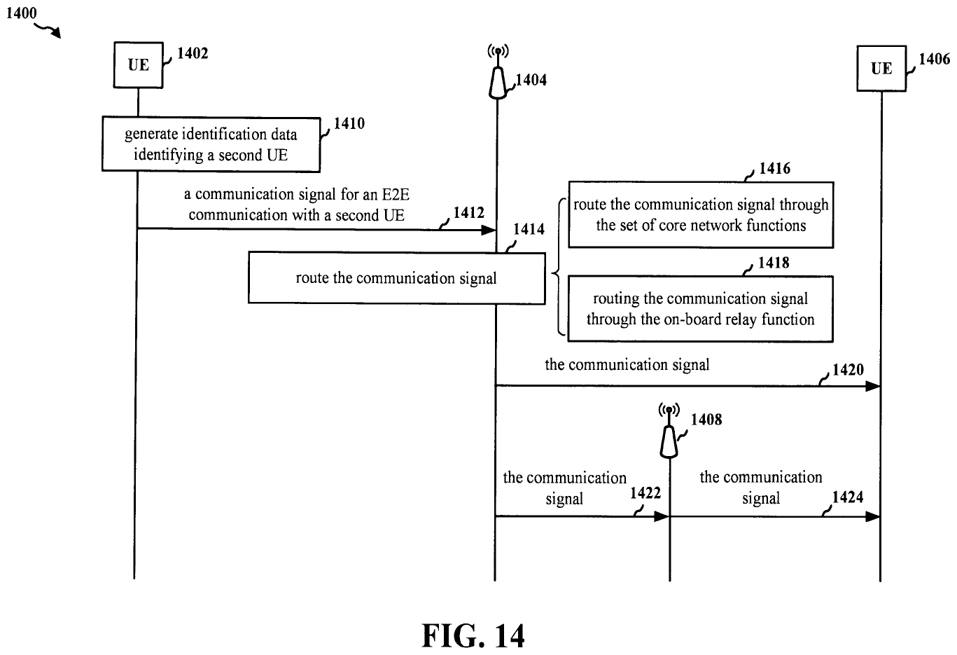

FIG. 14 is a call flow diagram 1400 illustrating a method of wireless communication in accordance with various aspects of this present disclosure. Example aspects are described in connection with a UE 1402, a base station 1404, a UE 1406, and a base station 1408. Various aspects may be performed by a base station 1404 in aggregation and/or by one or more components of a base station 1404 (e.g., such as a CU 110, a DU 130, and/or an RU 140) and UE 1402.

As shown in FIG. 14, UE 1402 (e.g., a first UE) may, at 1410, generate identification data identifying a second UE. The second UE may be UE 1406.

At 1412, UE 1402 may transmit a communication signal for an E2E communication with the second UE to a base station (e.g., base station 1404). The communication signal may include identification data for identifying the first UE and/or the second UE for the E2E communication. In some aspects, the E2E communication may be a direct NTN communication. For example, referring to FIG. 9. UE 902 may transmit a communication signal for a direct NTN communication with the second UE (e.g., UE2 906) to a base station (satellite 904). The communication signal may include identification data for identifying the first UE (e.g., UE1 902) and/or the second UE (e.g., UE2 906) for the direct NTN communication.

At 1414, base station 1404 may route the communication signal through the base station 1404. The communication signal may bypass ground-based feeder links. For example, referring to FIG. 9, the base station (satellite 904) may route the communication signal (data in the PHY layer 922, the MAC layer 924, the RLC layer 926, etc.) through the base station (satellite 904).

In some aspects, at 1416, base station 1404 may route the communication signal through the set of core network functions. For example, referring to FIG. 6A, the base station (satellite 604) may route the communication signal through the set of core network functions (routing data on the AS layer 610 and/or the NAS layer 620).

In some aspects, at 1418, base station 1404 may route the communication signal through onboard relay functions. For example, referring to FIG. 7A, a base station (satellite 904) may route the communication signal through onboard relay functions.

In some aspects, at 1420, base station 1404 may transmit the communication signal to UE 1406 to enable the direct NTN communication between UE 1402 and UE 1406. For example, referring to FIG. 6A, a base station (satellite 604) may transmit the communication signal to UE 606 to enable the direct NTN communication between UE 602 and UE 606. Referring to FIG. 7A, a base station (satellite 704) may transmit the communication signal to UE 706 to enable the direct NTN communication between UE 702 and UE 706. In some aspects, the communication signal may include identification data for identifying the first UE (e.g., UE1 902) and/or the second UE (e.g., UE2 906) for the direct NTN communication. In one example, the identification data helps the second UE (e.g., UE2 906) to identify the first UE (e.g., UE1 902). In some aspects, base station 1404 may transmit the communication signal to UE 1406 through base station 1408. That is, base station 1404 may, at 1422, transmit the communication signal to base station 1408, and base station 1408 may, at 1424, transmit the communication signal to UE 1406. For example, referring to FIG. 6A, a base station (satellite 634) may transmit the communication signal to UE 606 through another base station (satellite 636) through an inter-node link, such as the ISL 638.

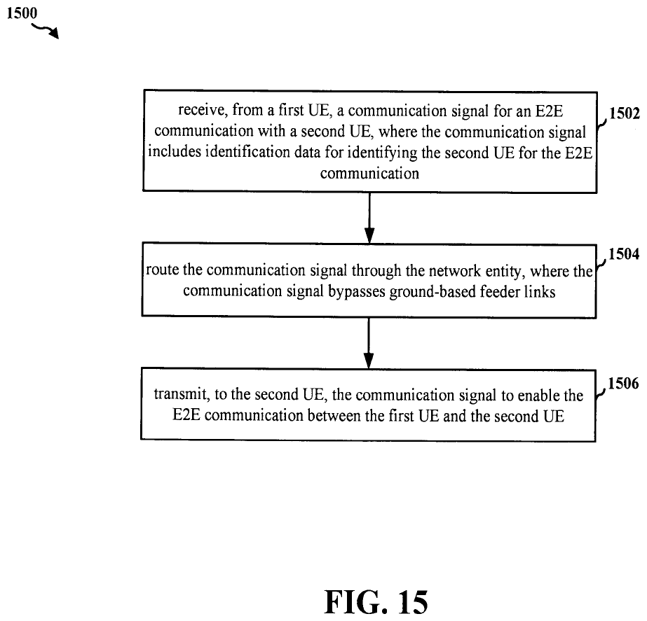

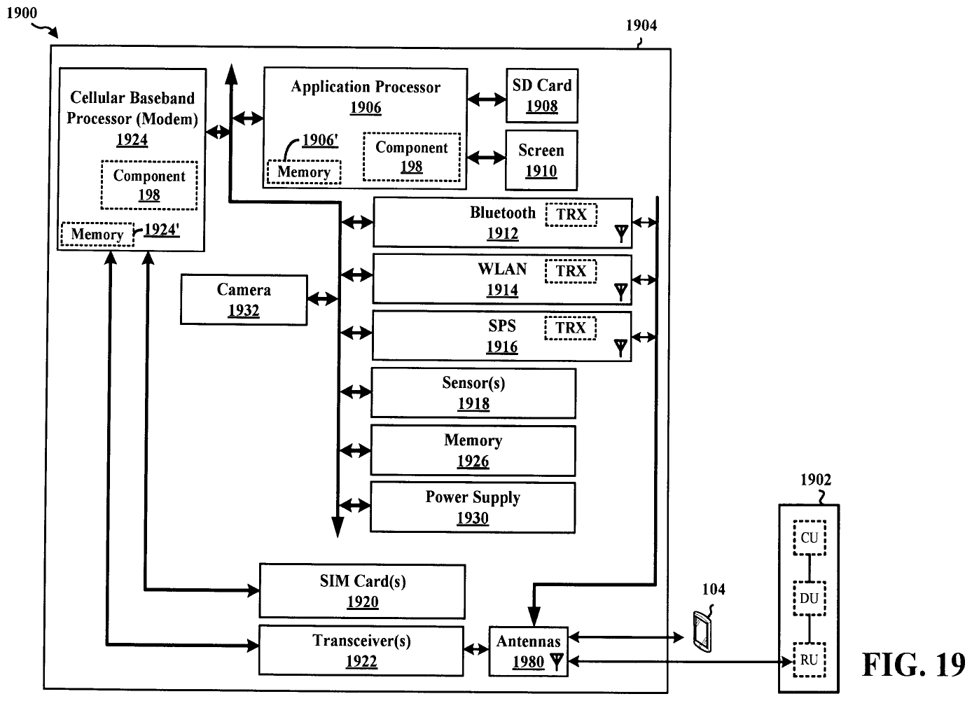

FIG. 15 is a flowchart 1500 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 1404; satellite 604, 654, 704, 754, 1304, or the network entity 1902 in the hardware implementation of FIG. 19). The method provides an E2E communication architecture that enhances connectivity between UEs without relying on ground networks or feeder links. The method minimizes latency and reduces the load on feeder links and enables inter-UE communication where a feeder link to the ground network is unavailable. Hence, the method substantially improves the availability and reliability of wireless communication.

As shown in FIG. 15, at 1502, the network entity may receive, from a first UE, a communication signal for an E2E communication with a second UE. The communication signal may include identification data for identifying the second UE for the E2E communication. The first UE may be the UE 104, 350, 602, 652, 702, 752, 1302, 1402, or the apparatus 1904 in the hardware implementation of FIG. 19. The second UE may be the UE 104, 350, 606, 656, 706, 756, 1306, 1406, or the apparatus 1904 in the hardware implementation of FIG. 19. FIGS. 6A, 6B, 7A, 7B, 13, and 14 illustrate various aspects of the steps in connection with flowchart 1500. For example, referring to FIG. 14, the network entity (base station 1404) may receive, at 1412, from a first UE 1402, a communication signal for an E2E communication with a second UE 1406. Referring to FIG. 6A, the network entity (satellite 604) may receive, from a first UE 602, a communication signal for an E2E communication with a second UE 606. In some aspects, 1502 may be performed by the direct NTN communication component 199.

At 1504, the network entity may route the communication signal through the network entity. The communication signal may bypass ground-based feeder links. For example, referring to FIG. 6A, the network entity (satellite 604) may route the communication signal through the network entity (satellite 604). The communication signal may bypass ground-based feeder links. In some aspects, 1504 may be performed by the direct NTN communication component 199.

At 1506, the network entity may transmit, to the second UE, the communication signal to enable the E2E communication between the first UE and the second UE. For example, referring to FIG. 14, the network entity (base station 1404) may transmit, at 1420, to the second UE 1406, the communication signal to enable the E2E communication between the first UE 1402 and the second UE 1406. Referring to FIG. 6A, the network entity (satellite 604) may transmit, to the second UE 606, the communication signal to enable the E2E communication between the first UE 602 and the second UE 606. In some aspects, 1506 may be performed by the direct NTN communication component 199.

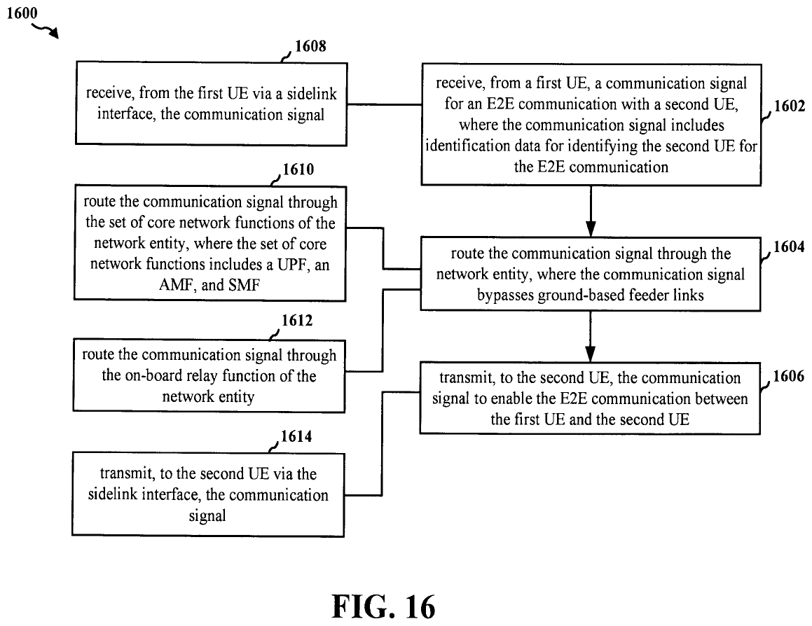

FIG. 16 is a flowchart 1600 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 1404; satellite 604, 654, 704, 754, 1304, or the network entity 1902 in the hardware implementation of FIG. 19). The method provides an E2E communication architecture that enhances connectivity between UEs without relying on ground networks or feeder links. The method minimizes latency and reduces the load on feeder links and enables inter-UE communication where a feeder link to the ground network is unavailable. Hence, the method substantially improves the availability and reliability of wireless communication.

As shown in FIG. 16, at 1602, the network entity may receive, from a first UE, a communication signal for an E2E communication with a second UE. The communication signal may include identification data for identifying the second UE for the E2E communication. The first UE may be the UE 104, 350, 602, 652, 702, 752, 1302, 1402, or the apparatus 1904 in the hardware implementation of FIG. 19. The second UE may be the UE 104, 350, 606, 656, 706, 756, 1306, 1406, or the apparatus 1904 in the hardware implementation of FIG. 19. FIGS. 6A, 6B, 7A, 7B, 13, and 14 illustrate various aspects of the steps in connection with flowchart 1600. For example, referring to FIG. 14, the network entity (base station 1404) may receive, at 1412, from a first UE 1402, a communication signal for an E2E communication with a second UE 1406. Referring to FIG. 6A, the network entity (satellite 604) may receive, from a first UE 602, a communication signal for an E2E communication with a second UE 606. In some aspects, 1602 may be performed by the direct NTN communication component 199.

At 1604, the network entity may route the communication signal through the network entity. The communication signal may bypass ground-based feeder links. For example, referring to FIG. 6A, the network entity (satellite 604) may route the communication signal through the network entity (satellite 604). The communication signal may bypass ground-based feeder links. In some aspects, 1604 may be performed by the direct NTN communication component 199.

At 1606, the network entity may transmit, to the second UE, the communication signal to enable the E2E communication between the first UE and the second UE. For example, referring to FIG. 14, the network entity (base station 1404) may transmit, at 1420, to the second UE 1406, the communication signal to enable the E2E communication between the first UE 1402 and the second UE 1406. Referring to FIG. 6A, the network entity (satellite 604) may transmit, to the second UE 606, the communication signal to enable the E2E communication between the first UE 602 and the second UE 606. In some aspects, 1606 may be performed by the direct NTN communication component 199.

In some aspects, the E2E communication may be a direct NTN communication, and the network entity may be a first satellite in a first NTN. For example, referring to FIG. 6A, the E2E communication between the UEs (e.g., UE 602 and UE 606) may be a direct NTN communication, and the network entity may be a first satellite (satellite 604) in a first NTN.

In some aspects, to receive the communication signal from the first UE, the network entity may be configured to receive the identification data for identifying at least one of the first UE and the second UE, and to transmit the communication signal to the second UE, the network entity may be configured to transmit the identification data for identifying at least one of the first UE and the second UE. For example, referring to FIG. 6A, to receive the communication signal from the first UE (e.g., UE 602), the network entity (e.g., satellite 604) may be configured to receive the identification data for identifying at least one of the first UE (e.g., UE 602) and the second UE (e.g., UE 606), and to transmit the communication signal to the second UE (e.g., UE 606), the network entity (e.g., satellite 604) may be configured to transmit the identification data for identifying at least one of the first UE (e.g., UE 602) and the second UE (e.g., UE 606).

In some aspects, the network entity may be a first network entity, and to transmit the communication signal, the network entity may be configured to transmit, to the second UE, the communication signal via a second network entity. The second network entity may be a second satellite in the first NTN, and the first network entity and the second network entity may be connected via an inter-node link. For example, referring to FIG. 6A, the network entity may be a first network entity (satellite 634), and to transmit the communication signal, the network entity (satellite 634) may be configured to transmit, to the second UE 606, the communication signal via a second network entity (satellite 636). The second network entity (satellite 636) may be a second satellite in the first NTN, and the first network entity (satellite 634) and the second network entity (satellite 636) may be connected via an inter-node link (e.g., the ISL 638).

In some aspects, the network entity may be equipped with a set of core network functions, and, to route the communication signal through the network entity, the network entity may be configured to, at 1610, route the communication signal through the set of core network functions of the network entity. The set of core network functions may include at least one of a UPF, an AMF, and an SMF. For example, referring to FIG. 6A, the network entity (satellite 604) may be equipped with a set of core network functions. To route the communication signal, the network entity (satellite 604) may be configured to route the communication signal through the set of core network functions of the network entity (satellite 604).

In some aspects, to receive the communication signal for the E2E communication, the network entity may be configured to, at 1608, receive, from the first UE via a sidelink interface, the communication signal. To transmit the communication signal, the network entity may be configured to, at 1614, transmit, to the second UE via the sidelink interface, the communication signal. For example, referring to FIG. 13, the network entity (satellite 1304) may be configured to receive, from the first UE 1302, via the sidelink interface, the communication, and transmit, to the second UE 1306, via the sidelink interface, the communication signal.

In some aspects, the network entity may be equipped with an onboard relay function. To route the communication signal through the network entity, the network entity may be configured to, at 1612, route the communication signal through the onboard relay function of the network entity. For example, referring to FIG. 7A, the network entity (satellite 704) may be equipped with an onboard relay function. And the network entity (satellite 704) may be configured to route the communication signal from UE 702 to UE 706 through the onboard relay function.

In some aspects, the identification data may be received via an identification layer. For example, referring to FIG. 9, the identification data may be received via an identification layer (the AL layer 910).

In some aspects, the identification data may be based on one or more of an IP address of the second UE, a QoS flow, an RB, an LCH, an RNTI, a peer UE's location, or a header of the identification layer. For example, referring to FIG. 9, the identification data in the AL layer 910 may be based on one or more of an IP address of the second UE 906, the QoS flow, the RB, the LCH, the RNTI, a peer UE's location, or a header of the identification layer (AL layer 910).

In some aspects, the identification data may be based on an ID of the first UE. For example, referring to FIG. 9, the identification data (in the AL layer 910) may be based on an ID of the first UE 902.

In some aspects, the communication signal may further include first data on an AS layer. To receive the communication signal for the E2E communication, the network entity may be configured to receive, from the first UE, the first data via a UE-RAN air interface. To transmit the communication signal, the network entity may be configured to transmit, to the second UE, the first data via the UE-RAN air interface. For example, referring to FIG. 9, the communication signal may further include first data on an AS layer 920. To receive the communication signal for the E2E communication, the network entity (satellite 904) may be configured to receive, from the first UE 902, the first data (data on the AS layer 920) via a UE-RAN air interface (e.g., the Uu air interface). To transmit the communication signal, the network entity (satellite 904) may be configured to transmit, to the second UE 906, the first data via the UE-RAN air interface (e.g., the Uu air interface).

In some aspects, the AS layer may include one or more of: a PHY layer, a MAC layer, an RLC layer, a PDCP layer, or an SDAP layer. For example, referring to FIG. 9, the AS layer 920 may include one or more of a PHY layer 922, a MAC layer 924, an RLC layer 926, a PDCP layer 928, or an SDAP layer 930.

In some aspects, the identification layer may be higher than the AS layer in a set of layers. For example, referring to FIG. 9, the identification layer (the AL layer 910) may be higher than the AS layer 920 in a set of layers.

In some aspects, the communication signal may further include second data on a user layer, and a first transmission of the second data may include a set of first terminations at the first UE and the second UE. For example, referring to FIG. 7B, the communication signal may further include second data on a user layer (upper layer 780), and a first transmission of the second data may include a set of first terminations at the first UE 752 and the second UE 756.

In some aspects, the communication signal may further include third data on an E2E control layer for controlling an operation of the second UE. A second transmission of the third data may include a set of second terminations at the first UE and the second UE. For example, referring to FIG. 10, the communication signal may further include third data on an E2E control layer (the E2E RRC/NAS layer 1020) for controlling an operation of the second UE 1006. A second transmission of the third data may include a set of second terminations at the first UE 1002 and the second UE 1006.

In some aspects, the communication signal may further include first data on a PHY layer, a MAC layer, and an RLC layer. To receive the communication signal for the E2E communication, the network entity may be configured to receive, from the first UE, the first data via a UE-RAN air interface. To transmit the communication signal, the network entity may be configured to transmit, to the second UE, the first data via the UE-RAN air interface. For example, referring to FIG. 9, the communication signal may further include first data on a PHY layer 922, a MAC layer 924, and an RLC layer 926. To receive the communication signal for the E2E communication, the network entity (satellite 904) may be configured to receive, from the first UE 902, the first data via a UE-RAN air interface (e.g., the Uu air interface). To transmit the communication signal, the network entity (satellite 904) may be configured to transmit, to the second UE 906, the first data via the UE-RAN air interface (e.g., the Uu air interface).

In some aspects, the identification layer may be higher than the RLC layer in a set of layers. For example, referring to FIG. 12, the identification layer (the AL layer 1210) may be higher than the RLC layer 1208 in a set of layers.

In some aspects, the communication signal may further include second data on a PDCP layer on an E2E user plane, and a first transmission of the second data may include a set of first terminations at the first UE and the second UE. For example, referring to FIG. 11, the communication signal may further include second data on a PDCP layer 1112 on an E2E user plane. A first transmission of the second data may include a set of first terminations at the first UE 1102 and the second UE 1106.

In some aspects, the second data may be transmitted via the UE-RAN air interface or a sidelink (PC5) interface. For example, referring to FIG. 11, the second data (data in the PDCP layer 1112) may be transmitted via the UE-RAN air interface (e.g., the Uu air interface) or a sidelink (PC5) interface.

In some aspects, the communication signal may further include third data on an E2E control layer for controlling an operation of the second UE. A second transmission of the third data may include a set of second terminations at the first UE and the second UE. For example, referring to FIG. 12, the communication signal may further include third data on an E2E control layer (E2E RRC/NAS layer 1220) for controlling an operation of the second UE 1206. A second transmission of the third data (data on the E2E RRC/NAS layer 1220) may include a set of second terminations at the first UE 1202 and the second UE 1206.

In some aspects, the network entity may be equipped with a set of radio access network functions, and, to route the communication signal through the network entity, the network entity may be configured to route the communication signal through the set of radio access network functions of the network entity. For example, referring to FIG. 7A, the network entity (satellite 704) may be equipped with a set of radio access network functions, and the network entity (satellite 704) may be configured to route the communication signal through the set of radio access network functions of the network entity (satellite 704).

In some aspects, the set of radio access network functions may include at least a part of functions of an onboard access network node. For example, referring to FIG. 7A, the set of radio access network functions in the satellite 704 may include at least a part of functions of an onboard access network node.

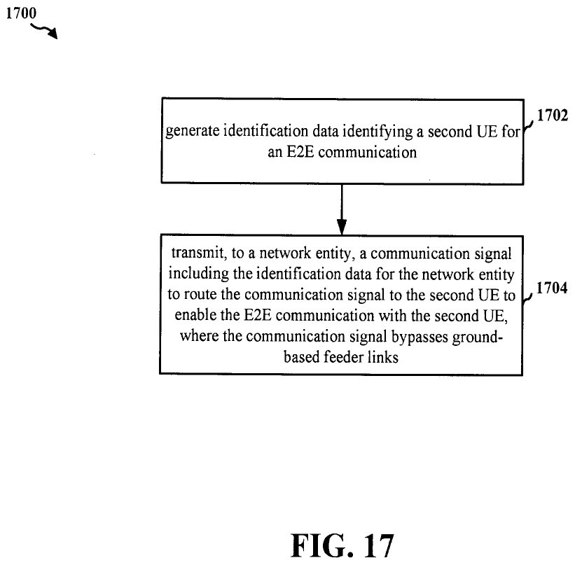

FIG. 17 is a flowchart 1700 illustrating methods of wireless communication at a first UE in accordance with various aspects of the present disclosure. The method may be performed by the first UE. The first UE may be the UE 104, 350, 602, 652, 702, 752, 1302, 1402, or the apparatus 1904 in the hardware implementation of FIG. 19. The method provides an E2E communication architecture that enhances connectivity between UEs without relying on ground networks or feeder links. The method minimizes latency and reduces the load on feeder links and enables inter-UE communication where a feeder link to the ground network is unavailable. Hence, the method substantially improves the availability and reliability of wireless communication.

As shown in FIG. 17, at 1702, the first UE may generate identification data identifying a second UE for an E2E communication. The second UE may be the UE 104, 350, 606, 656, 706, 756, 1306, 1406, or the apparatus 1904 in the hardware implementation of FIG. 19. FIGS. 6A, 6B, 7A, 7B. 13, and 14 illustrate various aspects of the steps in connection with flowchart 1700. For example, referring to FIG. 14, the first UE 1402 may generate, at 1410, identification data identifying a second UE 1406 for an E2E communication. In some aspects, 1702 may be performed by the direct NTN communication component 198.

At 1704, the first UE may transmit, to a network entity, a communication signal including the identification data for the network entity to route the communication signal to the second UE to enable the E2E communication with the second UE. The communication signal may bypass ground-based feeder links. The network entity may be a base station, or a component of a base station, in the access network of FIG. 1 or a core network component (e.g., base station 102, 310, 1404; satellite 604, 654, 704, 754, 1304, or the network entity 1902 in the hardware implementation of FIG. 19). For example, referring to FIG. 14, the first UE 1402 may transmit, at 1412, to a network entity (base station 1404), a communication signal including the identification data for the network entity (base station 1404) to route the communication signal to the second UE 1406 to enable the E2E communication with the second UE 1406. The communication signal may bypass ground-based feeder links. In some aspects, 1704 may be performed by the direct NTN communication component 198.

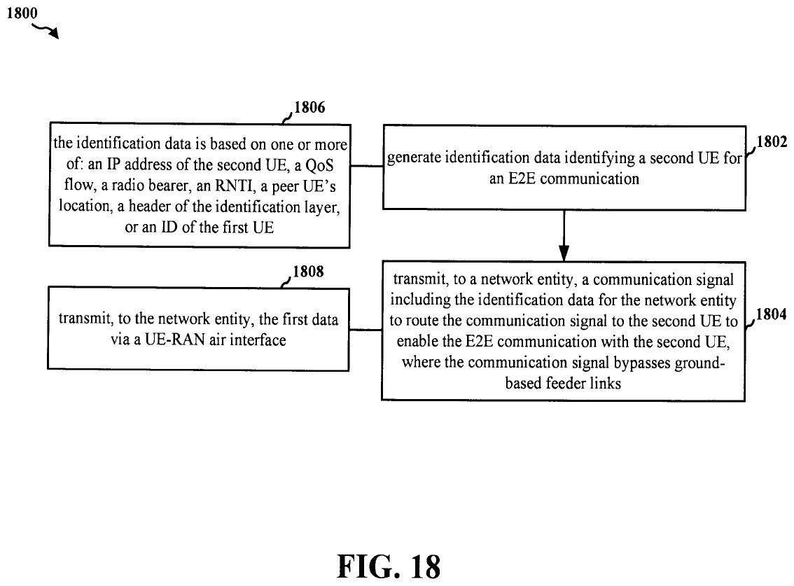

FIG. 18 is a flowchart 1800 illustrating methods of wireless communication at a first UE in accordance with various aspects of the present disclosure. The method may be performed by the first UE. The first UE may be the UE 104, 350, 602, 652, 702, 752, 1302, 1402, or the apparatus 1904 in the hardware implementation of FIG. 19. The method provides an E2E communication architecture that enhances connectivity between UEs without relying on ground networks or feeder links. The method minimizes latency and reduces the load on feeder links and enables inter-UE communication where a feeder link to the ground network is unavailable. Hence, the method substantially improves the availability and reliability of wireless communication.

As shown in FIG. 18, at 1802, the first UE may generate identification data identifying a second UE for an E2E communication. The second UE may be the UE 104, 350, 606, 656, 706, 756, 1306, 1406, or the apparatus 1904 in the hardware implementation of FIG. 19. FIGS. 6A, 6B, 7A, 7B, 13, and 14 illustrate various aspects of the steps in connection with flowchart 1800. For example, referring to FIG. 14, the first UE 1402 may generate, at 1410, identification data identifying a second UE 1406 for an E2E communication. In some aspects, 1802 may be performed by the direct NTN communication component 198.

At 1804, the first UE may transmit, to a network entity, a communication signal including the identification data for the network entity to route the communication signal to the second UE to enable the E2E communication with the second UE. The communication signal may bypass ground-based feeder links. The network entity may be a base station, or a component of a base station, in the access network of FIG. 1 or a core network component (e.g., base station 102, 310, 1404; satellite 604, 654, 704, 754, 1304, or the network entity 1902 in the hardware implementation of FIG. 19). For example, referring to FIG. 14, the first UE 1402 may transmit, at 1412, to a network entity (base station 1404), a communication signal including the identification data for the network entity (base station 1404) to route the communication signal to the second UE 1406 to enable the E2E communication with the second UE 1406. The communication signal may bypass ground-based feeder links. In some aspects, 1804 may be performed by the direct NTN communication component 198.

In some aspects, the E2E communication may be a direct NTN communication, and the network entity may be a first satellite in a first NTN. For example, referring to FIG. 6A, the E2E communication may be a direct NTN communication, and the network entity may be a first satellite (satellite 604) in a first NTN.

In some aspects, the identification data may be transmitted via an identification layer. For example, referring to FIG. 9, the identification data may be transmitted via an identification layer (the AL layer 910).

In some aspects, at 1806, the identification data may be based on one or more of an IP address of the second UE, a QoS flow, an RB, an LCH, an RNTI, a peer UE's location, a header of the identification layer, or an ID of the first UE. For example, referring to FIG. 9, the identification data in the AL layer 910 may be based on one or more of an IP address of the second UE 906, the QoS flow, the RB, the LCH, the RNTI, a peer UE's location, or a header of the identification layer (AL layer 910).

In some aspects, the communication signal may further include first data on an AS layer. To transmit the communication signal, the first UE may be configured to: transmit, at 1808, to the network entity, the first data via a UE-RAN air interface. For example, referring to FIG. 9, the communication signal may further include first data on an AS layer 920. To transmit the communication signal, the first UE 902 may be configured to transmit to the network entity (satellite 904) the first data (data in the AS layer 920) via a UE-RAN air interface (e.g., the Uu air interface).

In some aspects, the AS layer may include one or more of: a PHY layer, a MAC layer, an RLC layer, a PDCP layer, or an SDAP layer. For example, referring to FIG. 9, the AS layer 920 may include one or more of a PHY layer 922, a MAC layer 924, an RLC layer 926, a PDCP layer 928, or an SDAP layer 930.

In some aspects, the identification layer may be higher than the AS layer in a set of layers. For example, referring to FIG. 9, the identification layer (the AL layer 910) may be higher than the AS layer 920 in a set of layers.

In some aspects, the communication signal may further include first data on a PHY layer, a MAC layer, and an RLC layer. To transmit the communication signal, the first UE may be configured to transmit, at 1808, to the network entity, the first data via a UE-RAN air interface. For example, referring to FIG. 9, the communication signal may further include first data on a PHY layer 922, a MAC layer 924, and an RLC layer 926. To transmit the communication signal, the first UE 902 may be configured to transmit, to the network entity (satellite 904), the first data (e.g., data in the PHY layer 922, the MAC layer 924, and the RLC layer 926) via a UE-RAN air interface (e.g., the Uu air interface).

In some aspects, the identification layer may be higher than the RLC layer in a set of layers. For example, referring to FIG. 12, the identification layer (the AL layer 1210) may be higher than the RLC layer 1208 in a set of layers.

FIG. 19 is a diagram 1900 illustrating an example of a hardware implementation for an apparatus 1904. The apparatus 1904 may be a UE, a component of a UE, or may implement UE functionality. In some aspects, the apparatus 1904 may include a cellular baseband processor 1924 (also referred to as a modem) coupled to one or more transceivers 1922 (e.g., cellular RF transceiver). The cellular baseband processor 1924 may include on-chip memory 1924′. In some aspects, the apparatus 1904 may further include one or more subscriber identity modules (SIM) cards 1920 and an application processor 1906 coupled to a secure digital (SD) card 1908 and a screen 1910. The application processor 1906 may include on-chip memory 1906′. In some aspects, the apparatus 1904 may further include a Bluetooth module 1912, a WLAN module 1914, an SPS module 1916 (e.g., GNSS module), one or more sensor modules 1918 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1926, a power supply 1930, and/or a camera 1932. The Bluetooth module 1912, the WLAN module 1914, and the SPS module 1916 may include an on-chip transceiver (TRX) (or in some cases, just a receiver (RX)). The Bluetooth module 1912, the WLAN module 1914, and the SPS module 1916 may include their own dedicated antennas and/or utilize the antennas 1980 for communication. The cellular baseband processor 1924 communicates through the transceiver(s) 1922 via one or more antennas 1980 with the UE 104 and/or with an RU associated with a network entity 1902. The cellular baseband processor 1924 and the application processor 1906 may each include a computer-readable medium/memory 1924′, 1906′, respectively. The additional memory modules 1926 may also be considered a computer-readable medium/memory. Each computer-readable medium/memory 1924′, 1906′, 1926 may be non-transitory. The cellular baseband processor 1924 and the application processor 1906 are each responsible for general processing, including the execution of software stored on the computer-readable medium/memory. The software, when executed by the cellular baseband processor 1924/application processor 1906, causes the cellular baseband processor 1924/application processor 1906 to perform the various functions described supra. The computer-readable medium/memory may also be used for storing data that is manipulated by the cellular baseband processor 1924/application processor 1906 when executing software. The cellular baseband processor 1924/application processor 1906 may be a component of the UE 350 and may include the memory 360 and/or at least one of the TX processor 368, the RX processor 356, and the controller/processor 359. In one configuration, the apparatus 1904 may be a processor chip (modem and/or application) and include just the cellular baseband processor 1924 and/or the application processor 1906, and in another configuration, the apparatus 1904 may be the entire UE (e.g., see UE 350 of FIG. 3) and include the additional modules of the apparatus 1904.

As discussed supra, the component 198 may be configured to generate identification data identifying a second UE for an E2E communication; and transmit, to a network entity, a communication signal including the identification data for the network entity to route the communication signal to the second UE to enable the E2E communication with the second UE, where the communication signal bypasses ground-based feeder links. The component 198 may be further configured to perform any of the aspects described in connection with the flowcharts in FIG. 17 and FIG. 18, and/or performed by the UE 1402 in FIG. 14. The component 198 may be within the cellular baseband processor 1924, the application processor 1906, or both the cellular baseband processor 1924 and the application processor 1906. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1904 may include a variety of components configured for various functions. In one configuration, the apparatus 1904, and in particular the cellular baseband processor 1924 and/or the application processor 1906, includes means for generating identification data identifying a second UE for an E2E communication, and means for transmitting, to a network entity, a communication signal including the identification data for the network entity to route the communication signal to the second UE to enable the E2E communication with the second UE, where the communication signal bypasses ground-based feeder links. The apparatus 1904 may further include means for performing any of the aspects described in connection with the flowcharts in FIG. 17 and FIG. 18, and/or aspects performed by the UE 1402 in FIG. 14. The means may be the component 198 of the apparatus 1904 configured to perform the functions recited by the means. As described supra, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

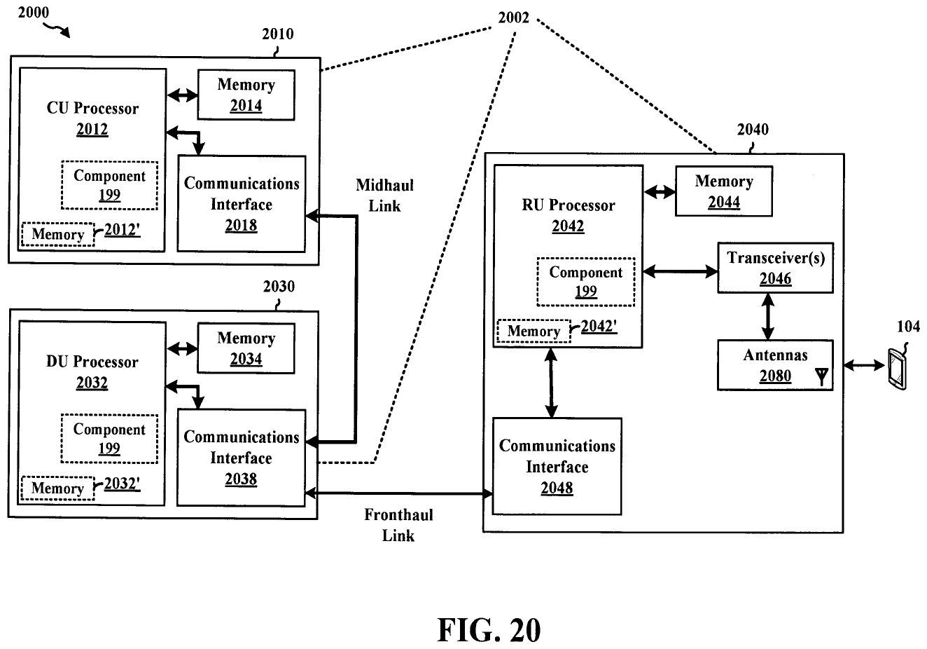

FIG. 20 is a diagram 2000 illustrating an example of a hardware implementation for a network entity 2002. The network entity 2002 may be a BS, a component of a BS, or may implement BS functionality. The network entity 2002 may include at least one of a CU 2010, a DU 2030, or an RU 2040. For example, depending on the layer functionality handled by the component 199, the network entity 2002 may include the CU 2010; both the CU 2010 and the DU 2030; each of the CU 2010, the DU 2030, and the RU 2040; the DU 2030; both the DU 2030 and the RU 2040; or the RU 2040. The CU 2010 may include a CU processor 2012. The CU processor 2012 may include on-chip memory 2012′. In some aspects, the CU 2010 may further include additional memory modules 2014 and a communications interface 2018. The CU 2010 communicates with the DU 2030 through a midhaul link, such as an F1 interface. The DU 2030 may include a DU processor 2032. The DU processor 2032 may include on-chip memory 2032′. In some aspects, the DU 2030 may further include additional memory modules 2034 and a communications interface 2038. The DU 2030 communicates with the RU 2040 through a fronthaul link. The RU 2040 may include an RU processor 2042. The RU processor 2042 may include on-chip memory 2042′. In some aspects, the RU 2040 may further include additional memory modules 2044. one or more transceivers 2046, antennas 2080, and a communications interface 2048. The RU 2040 communicates with the UE 104. The on-chip memory 2012′, 2032′, 2042′ and the additional memory modules 2014, 2034, 2044 may each be considered a computer-readable medium/memory. Each computer-readable medium/memory may be non-transitory. Each of the processors 2012, 2032, 2042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive, from a first UE, a communication signal for an E2E communication with a second UE, where the communication signal includes identification data for identifying the second UE for the E2E communication; route the communication signal through the network entity, where the communication signal bypasses ground-based feeder links; and transmit, to the second UE, the communication signal to enable the E2E communication between the first UE and the second UE. The component 199 may be further configured to perform any of the aspects described in connection with the flowcharts in FIG. 15 and FIG. 16, and/or performed by the base station 1404 in FIG. 14. The component 199 may be within one or more processors of one or more of the CU 2010, DU 2030, and the RU 2040. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2002 may include a variety of components configured for various functions. In one configuration, the network entity 2002 includes means for receiving, from a first UE, a communication signal for an E2E communication with a second UE, where the communication signal includes identification data for identifying the second UE for the E2E communication, means for routing the communication signal through the network entity, where the communication signal bypasses ground-based feeder links, and means for transmitting, to the second UE, the communication signal to enable the E2E communication between the first UE and the second UE. The network entity 2002 may further include means for performing any of the aspects described in connection with the flowcharts in FIG. 15 and FIG. 16, and/or aspects performed by the base station 1404 in FIG. 14. The means may be the component 199 of the network entity 2002 configured to perform the functions recited by the means. As described supra, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving, from a first UE, a communication signal for an E2E communication with a second UE, where the communication signal includes identification data for identifying the second UE for the E2E communication; routing the communication signal through the network entity, where the communication signal bypasses ground-based feeder links; and transmitting, to the second UE, the communication signal to enable the E2E communication between the first UE and the second UE. The method provides an E2E communication architecture that enhances connectivity between UEs without relying on ground networks or feeder links. The method minimizes latency and reduces the load on feeder links and enables inter-UE communication where a feeder link to the ground network is unavailable. Hence, the method substantially improves the availability and reliability of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A. multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X. X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a network entity. The method may include receiving, from a first UE, a communication signal for an E2E communication with a second UE, where the communication signal includes identification data for identifying the second UE for the direct NTN communication; routing the communication signal through the network entity, where the communication signal bypasses ground-based feeder links; and transmitting, to the second UE, the communication signal to enable the E2E communication between the first UE and the second UE.
Aspect 2 is the method of aspect 1, where the E2E communication may be a direct NTN communication, and the network entity may be a first satellite in a first NTN.
Aspect 3, is the method of aspect 2, where receiving the communication signal from the first UE may include receiving the identification data for identifying at least one of the first UE and the second UE, and transmitting the communication signal to the second UE may include transmitting the identification data for identifying at least one of the first UE and the second UE.
Aspect 4 is the method of aspect 2, where the network entity may be a first network entity, and transmitting the communication signal may include: transmitting, to the second UE, the communication signal via a second network entity. The second network entity may be a second satellite in the first NTN, and the first network entity and the second network entity may be connected via an inter-node link.
Aspect 5 is the method of any of aspects 3 to 4, where the network entity may be equipped with a set of core network functions, and routing the communication signal through the network entity may include: routing the communication signal through the set of core network functions of the network entity. The set of core network functions may include at least one of a UPF, an AMF, and an SMF.
Aspect 6 is the method any of aspects 2 to 5, where receiving the communication signal for the E2E communication may include: receiving, from the first UE via a sidelink interface, the communication signal, and where transmitting the communication signal may include: transmitting, to the second UE via the sidelink interface, the communication signal.
Aspect 7 is the method of any of aspects 2 to 5, where the network entity may be equipped with an onboard relay function, and where routing the communication signal through the network entity may include: routing the communication signal through the onboard relay function of the network entity.
Aspect 8 is the method of aspect 7, where the identification data may be received via an identification layer.
Aspect 9 is the method of aspect 8, where the identification data may be based on one or more of: an IP address of the second UE, a QoS flow, an RB, an LCH, an RNTI, a peer UE's location, a header of the identification layer, or an ID of the first UE.
Aspect 10 is the method of any of aspects 7 to 9, where the communication signal may further include first data on an AS layer. Receiving the communication signal for the E2E communication may include: receiving, from the first UE, the first data via a UE-RAN air interface, and transmitting the communication signal may include: transmitting, to the second UE, the first data via the UE-RAN air interface.
Aspect 11 is the method of aspect 10, where the AS layer may include one or more of: a PHY layer, a MAC layer, an RLC layer, a PDCP layer, or an SDAP layer.
Aspect 12 is the method of any of aspects 10 to 11, where the identification layer may be higher than the AS layer in a set of layers.
Aspect 13 is the method of aspect 12, where the communication signal may further include second data on a user layer, and a first transmission of the second data may include a set of first terminations at the first UE and the second UE.
Aspect 14 is the method of aspect 13, where the communication signal may further include third data on an E2E control layer for controlling an operation of the second UE, and a second transmission of the third data may include a set of second terminations at the first UE and the second UE.
Aspect 15 is the method of any of aspects 7 to 14, where the communication signal may further include first data on a PHY layer, a MAC layer, and an RLC layer, and receiving the communication signal for the direct NTN communication may include: receiving, from the first UE, the first data via a Uu air interface, and where transmitting the communication signal may include: transmitting, to the second UE, the first data via the UE-RAN air interface.
Aspect 16 is the method of aspect 15, where the identification layer may be higher than the RLC layer in a set of layers.
Aspect 17 is the method of aspect 16, where the communication signal may further include second data on a PDCP layer on an E2E UP, and a first transmission of the second data may include a set of first terminations at the first UE and the second UE.
Aspect 18 is the method of aspect 17, where the second data may be transmitted via the UE-RAN air interface or a sidelink (PC5) interface.
Aspect 19 is the method of any of aspects 17 to 18, where the communication signal may further include third data on an E2E control layer for controlling an operation of the second UE. A second transmission of the third data may include a set of second terminations at the first UE and the second UE.
Aspect 20 is the method of aspect 2, where the network entity may be equipped with a set of radio access network functions, and routing the communication signal through the network entity may include: routing the communication signal through the set of radio access network functions of the network entity.
Aspect 21 is the method of aspect 20, where the set of radio access network functions may include at least a part of functions of an onboard access network node.
Aspect 22 is an apparatus for wireless communication at a UE, including: a memory; and at least one processor coupled to the memory and, based at least in part on information stored in the memory, the at least one processor is configured to perform the method of any of aspects 1-21.
Aspect 23 is the apparatus of aspect 22, further including at least one of a transceiver or an antenna coupled to the at least one processor and configured to receive the communication signal.
Aspect 24 is an apparatus for wireless communication including means for implementing the method of any of aspects 1-21.
Aspect 25 is a computer-readable medium (e.g., a non-transitory computer-readable medium) storing computer executable code, where the code when executed by a processor causes the processor to implement the method of any of aspects 1-21.
Aspect 26 is a method of wireless communication at a UE. The method may include generating identification data identifying a second UE for an E2E communication; and transmitting, to a network entity, a communication signal including the identification data for the network entity to route the communication signal to the second UE to enable the E2E communication with the second UE. The communication signal may bypass ground-based feeder links.
Aspect 27 is the method of aspect 26, where the E2E communication may be a direct NTN communication, and the network entity may a first satellite in a first NTN.
Aspect 28 is the method of any of aspects 26 to 27, where the identification data may be transmitted via an identification layer, and the identification data may be based on one or more of: an IP address of the second UE, a QoS flow, an RB, an LCH, an RNTI, a peer UE's location, a header of the identification layer, or an ID of the first UE.
Aspect 29 is the method of aspect 28, where the communication signal may further include first data on an AS layer, the identification layer may be higher than the AS layer in a set of layers, and transmitting the communication signal may include: transmitting, to the network entity, the first data via a UE-RAN air interface.
Aspect 30 is the method of aspect 29, where the AS layer may include one or more of: a PHY layer, a MAC layer, an RLC layer, a PDCP layer, or an SDAP layer.
Aspect 31 is the method of any of aspects 28 to 30, where the communication signal may further include first data on a PHY layer, a MAC layer, and an RLC layer, and transmitting the communication signal may include transmitting, to the network entity, the first data via a UE-RAN air interface.
Aspect 32 is the method of aspect 31, where the identification layer may be higher than the RLC layer in a set of layers.
Aspect 33 is an apparatus for wireless communication at a network entity, including: a memory; and at least one processor coupled to the memory and, based at least in part on information stored in the memory, the at least one processor is configured to perform the method of any of aspects 26-32.
Aspect 34 is the apparatus of aspect 33, further including at least one of a transceiver or an antenna coupled to the at least one processor and configured to transmit the communication signal.
Aspect 35 is an apparatus for wireless communication including means for implementing the method of any of aspects 26-32.
Aspect 36 is a computer-readable medium (e.g., a non-transitory computer-readable medium) storing computer executable code, where the code when executed by a processor causes the processor to implement the method of any of aspects 26-32.

What is claimed is:

1. An apparatus of wireless communication at a network entity, comprising:
memory; and
at least one processor coupled to the memory and, based at least in part on information stored in the memory, the at least one processor is configured to:
receive, from a first user equipment (UE), a communication signal for an end-to-end (E2E) communication with a second UE, wherein the communication signal comprises identification data for identifying the second UE for the E2E communication;
route the communication signal through the network entity, wherein the communication signal bypasses ground-based feeder links; and
transmit, to the second UE, the communication signal to enable the E2E communication between the first UE and the second UE.

2. The apparatus of claim 1, further comprising a transceiver coupled to the at least one processor, wherein, to receive the communication signal, the at least one processor is configured to receive the communication signal via the transceiver, and wherein the E2E communication is a direct non-terrestrial network (NTN) communication, and the network entity is a first satellite in a first NTN.

3. The apparatus of claim 2, wherein, to receive the communication signal from the first UE, the at least one processor is configured to receive the identification data for identifying at least one of the first UE and the second UE, and to transmit the communication signal to the second UE, the at least one processor is configured to transmit the identification data for identifying at least one of the first UE and the second UE.

4. The apparatus of claim 2, wherein the network entity is a first network entity, and wherein, to transmit the communication signal, the at least one processor is configured to:
transmit, to the second UE, the communication signal via a second network entity, wherein the second network entity is a second satellite in the first NTN, and the first network entity and the second network entity are connected via an inter-node link.

5. The apparatus of claim 2, wherein the network entity is equipped with a set of core network functions, and wherein, to route the communication signal through the network entity, the at least one processor is configured to:
route the communication signal through the set of core network functions of the network entity, wherein the set of core network functions includes at least one of a user plane function (UPF), an access and mobility management function (AMF), and a session management function (SMF).

6. The apparatus of claim 2, wherein, to receive the communication signal for the E2E communication, the at least one processor is configured to:
receive, from the first UE via a sidelink interface, the communication signal, and wherein, to transmit the communication signal, the at least one processor is configured to:
transmit, to the second UE via the sidelink interface, the communication signal.

7. The apparatus of claim 2, wherein the network entity is equipped with an onboard relay function, and wherein, to route the communication signal through the network entity, the at least one processor is configured to:
route the communication signal through the onboard relay function of the network entity.

8. The apparatus of claim 7, wherein, to receive the communication signal, the at least one processor is configured to: receive the identification data via an identification layer.

9. The apparatus of claim 8, wherein the identification data is based on one or more of:
an Internet Protocol (IP) address of the second UE,
a quality of service (QOS) flow,
a radio bearer (RB),
a logical channel (LCH),
a radio network temporary identifier (RNTI),
a peer UE's location,
a header of the identification layer, or
an identifier (ID) of the first UE.

10. The apparatus of claim 8, wherein the communication signal further includes first data on an access stratum (AS) layer, wherein, to receive the communication signal for the E2E communication, the at least one processor is configured to:
receive, from the first UE, the first data via a UE-radio access network (RAN) (UE-RAN) air interface, and
wherein, to transmit the communication signal, the at least one processor is configured to:
transmit, to the second UE, the first data via the UE-RAN air interface.

11. The apparatus of claim 10, wherein the AS layer includes one or more of:
a physical (PHY) layer,
a medium access control (MAC) layer,
a radio link control (RLC) layer,
a packet data convergence protocol (PDCP) layer, or
a service data adaptation protocol (SDAP) layer.

12. The apparatus of claim 10, wherein the identification layer is higher than the AS layer in a set of layers.

13. The apparatus of claim 12, wherein the communication signal further includes second data on a user layer, and wherein a first transmission of the second data comprises a set of first terminations at the first UE and the second UE.

14. The apparatus of claim 12, wherein the communication signal further includes third data on an E2E control layer for controlling an operation of the second UE, wherein a second transmission of the third data comprises a set of second terminations at the first UE and the second UE.

15. The apparatus of claim 8, wherein the communication signal further includes first data on a physical (PHY) layer, a medium access control (MAC) layer, and a radio link control (RLC) layer, wherein, to receive the communication signal for the E2E communication, the at least one processor is configured to:
receive, from the first UE, the first data via a UE-radio access network (RAN) (UE-RAN) air interface, and
wherein, to transmit the communication signal, the at least one processor is configured to:
transmit, to the second UE, the first data via the UE-RAN air interface.

16. The apparatus of claim 15, wherein the identification layer is higher than the RLC layer in a set of layers.

17. The apparatus of claim 16, wherein the communication signal further includes second data on a packet data convergence protocol (PDCP) layer on an E2E user plane (UP), and wherein a first transmission of the second data comprises a set of first terminations at the first UE and the second UE.

18. The apparatus of claim 17, wherein, to receive the communication signal, the at least one processor is configured to: receive the second data via the UE-RAN air interface or a sidelink (PC5) interface.

19. The apparatus of claim 17, wherein the communication signal further includes third data on an E2E control layer for controlling an operation of the second UE, wherein a second transmission of the third data comprises a set of second terminations at the first UE and the second UE.

20. The apparatus of claim 2, wherein the network entity is equipped with a set of radio access network functions, and wherein, to route the communication signal through the network entity, the at least one processor is configured to:
route the communication signal through the set of radio access network functions of the network entity.

21. The apparatus of claim 20, wherein the set of radio access network functions includes at least a part of functions of an onboard access network node.

22. An apparatus of wireless communication at a first user equipment (UE), comprising:
memory; and
at least one processor coupled to the memory and, based at least in part on information stored in the memory, the at least one processor is configured to:
generate identification data identifying a second UE for an end-to-end (E2E) communication; and
transmit, to a network entity, a communication signal comprising the identification data for the network entity to route the communication signal to the second UE to enable the E2E communication with the second UE, wherein the communication signal bypasses ground-based feeder links.

23. The apparatus of claim 22, further comprising a transceiver coupled to the at least one processor, wherein, to transmit the communication signal, the at least one processor is configured to transmit the communication signal via the transceiver, and wherein the E2E communication is a direct non-terrestrial network (NTN) communication, and the network entity is a first satellite in a first NTN.

24. The apparatus of claim 23, wherein, to transmit the communication signal, the at least one processor is configured to: transmit the identification data via an identification layer, and wherein the identification data is based on one or more of:
an Internet Protocol (IP) address of the second UE,
a quality of service (QOS) flow,
a radio bearer (RB),
a logical channel (LCH),
a radio network temporary identifier (RNTI),
a peer UE's location,
a header of the identification layer, or
an identifier (ID) of the first UE.

25. The apparatus of claim 24, wherein the communication signal further includes first data on an access stratum (AS) layer, the identification layer is higher than the AS layer in a set of layers, and wherein, to transmit the communication signal, the at least one processor is configured to:
transmit, to the network entity, the first data via a UE-radio access network (RAN) (UE-RAN) air interface.

26. The apparatus of claim 25, wherein the AS layer includes one or more of:
a physical (PHY) layer,
a medium access control (MAC) layer,
a radio link control (RLC) layer,
a packet data convergence protocol (PDCP) layer, or
a service data adaptation protocol (SDAP) layer.

27. The apparatus of claim 24, wherein the communication signal further includes first data on a physical (PHY) layer, a medium access control (MAC) layer, and a radio link control (RLC) layer, wherein, to transmit the communication signal, the at least one processor is configured to:
transmit, to the network entity, the first data via a UE-radio access network (RAN) (UE-RAN) air interface.

28. The apparatus of claim 27, wherein the identification layer is higher than the RLC layer in a set of layers.

29. A method of wireless communication at a network entity, comprising:
receiving, from a first user equipment (UE), a communication signal for an end-to-end (E2E) communication with a second UE, wherein the communication signal comprises identification data for identifying the second UE for the E2E communication;
routing the communication signal through the network entity, wherein the communication signal bypasses ground-based feeder links; and
transmitting, to the second UE, the communication signal to enable the E2E communication between the first UE and the second UE.

30. A method of wireless communication at a first user equipment (UE), comprising:
generating identification data identifying a second UE for an end-to-end (E2E) communication; and
transmitting, to a network entity, a communication signal comprising the identification data for the network entity to route the communication signal to the second UE to enable the E2E communication with the second UE, wherein the communication signal bypasses ground-based feeder links.
